(19) United States
(12) Patent Application Publication
(10) Pub. No.: US 2017/0161954 A1
(43) Pub. Date: Jun. 8, 2017

(54) Method and Electronic Device for Processing Image

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Bo HUANG, Tianjin (CN)

(21) Appl. No.: 15/246,472

(22) Filed: Aug. 24, 2016

Related U.S. Application Data
(63) Continuation of application No. PCT/CN2016/089475, filed on Jul. 8, 2016.

(30) Foreign Application Priority Data
Dec. 4, 2015 (CN) 201510886134.2

(51) Int. Cl. G06T 19/00; G06T 11/60

(52) U.S. Cl. CPC G06T 19/006; G06T 11/60

(57) ABSTRACT

Disclosed are a method and an electronic device for processing an image. The method includes: first of all acquiring a data display characteristic value corresponding to live-action data; then determining whether a similarity between the data display characteristic value and a preset data display characteristic value is less than or equal to a preset threshold; acquiring virtual data corresponding to the preset data display characteristic value from a preset storage location when the similarity is less than or equal to the preset threshold, wherein the preset storage location saves virtual data respectively corresponding to different preset data display characteristic values; and finally superposing the live-action data and the virtual data and saving superposed data.

### CROSS REFERENCE TO RELATED APPLICATIONS

This application is a continuation of International Application No. PCT/CN2016/089475, filed on Jul. 8, 2016, which is based upon and claims priority to Chinese Patent Application No. 201510886134.2, filed on Dec. 4, 2015, the entire contents of all of which are incorporated herein by reference.

### TECHNICAL FIELD

The present disclosure relates to information technologies, and more particularly, to a method and an electronic device for processing an image.

### BACKGROUND

With the constant development of information technologies, functions of terminal devices become more and more powerful. Users may shoot current live-action images by means of terminal devices. However, with the constant development of terminal devices, terminal devices may also generate various virtual contents such as 3D models, images and videos or the like which can be generated by terminal devices through calculation. Therefore, it is a problem to be solved how to combine images shot by users with virtual contents to generate images having better effects.

At present, when virtual contents and live-action data are superposed, generally all content data within a screen are acquired by means of a global screen capturing function of a terminal device, and then the content data are combined with shot live-action images, thereby completing an operation of combination of the live-action images and the virtual contents. However, in a process of implementing the present disclosure, it is found that when virtual content data are acquired by means of the global screen capturing function, other data such as application icons and function button icons displayed on the current screen may also be acquired in addition to virtual data, which causes a poorer display effect of images generated after superposition and a lower image processing precision.

### SUMMARY

The present disclosure provides a method and an electronic device for processing an image to solve a problem in the prior art that an image generated after superposing live-action data and virtual data is poorer in effect and lower in image processing precision.

In a first aspect, embodiments of the present disclosure provide a method for processing an image, implemented by an electronic device, including:

acquiring a data display characteristic value corresponding to live-action data;

determining whether a similarity between the data display characteristic value and a preset data display characteristic value is less than or equal to a preset threshold;

acquiring virtual data corresponding to the preset data display characteristic value from a preset storage location when the similarity is less than or equal to the preset threshold, wherein the preset storage location saves virtual data respectively corresponding to different preset data display characteristic values; and

superposing the live-action data and the virtual data and saving superposed data.

In a second aspect, embodiments of the present disclosure provide a non-transitory computer-readable storage medium storing executable instructions, wherein the executable instructions are configured to perform any methods for processing an image mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for processing an image mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a method for processing an image in accordance with some embodiments;

FIG. 2 shows another method for processing an image in accordance with some embodiments;

FIG. 3 shows an apparatus for processing an image in accordance with some embodiments;

FIG. 4 shows another apparatus for processing an image in accordance with some embodiments; and

FIG. 5 is a block diagram of an electronic device which is configured to perform the methods for processing an image in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

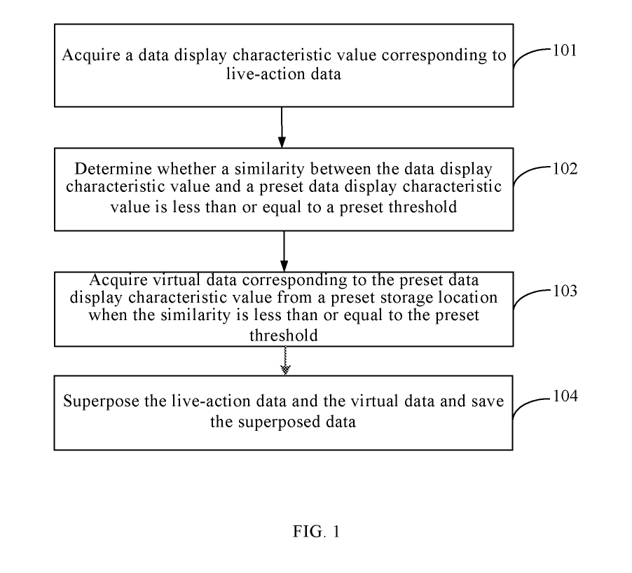

Embodiments of the present disclosure provide a method for processing an image, which can be applied to a terminal device such as a mobile phone, a computer, a personal computer or the like, as shown in FIG. 1, the method includes following steps.

101: A data display characteristic value corresponding to live-action data is acquired.

The live-action data can be a real image acquired currently in real time. For example, when a shooting instruction is received, the live-action data can be acquired by means of a preset camera. The data display characteristic value is used for marking a specific display location of the live-action data. The data display characteristic value specifically can be a gray value and/or a contrast value of data display, which is not limited in the embodiments of the present disclosure. Since gray values and/or contrast values corresponding to different locations may also be different, the specific location of live-action data can be reflected through gray values and/or contrast values. Each image datum respectively corresponds to one or one group of gray values and/or contrast values.

102: It is determined whether a similarity between the data display characteristic value and a preset data display characteristic value is less than or equal to a preset threshold.

The preset threshold can be configured according to actual demands, which is not limited in the embodiments of the present disclosure. For example, when a requirement for an accuracy of superposed data is relatively high, the preset threshold can be configured relatively small. However, when the requirement for the accuracy of superposed data is not high, the preset threshold can be configured relatively large.

103: Virtual data corresponding to the preset data display characteristic value are acquired from a preset storage location when the similarity is less than or equal to the preset threshold.

The preset storage location saves virtual data respectively corresponding to different preset data display characteristic values. Live-action data display locations reflected by different preset data display characteristic values are different. Therefore, corresponding virtual data are respectively configured for different preset data display characteristic values, which can ensure that superposition of the virtual data and the live-action data does not lead to a location overlap, thereby ensuring a display effect of superposed data. The virtual data can be data contents generated by smart devices through calculation, for example, 3D models, images, videos and so on. The preset storage location can be divided into different layers, specifically divided into different layers according to a layered manner of a system display framework of a smart Android device, for example, divided into three layers by means of layering, a Layer1, a Layer2 and a Layer3 respectively. Data attributes can be file type attributes. For example, data whose file type attributes are multimedia files such as video files are saved in the Layer1, and data whose file type attributes are model files such as icons, 3D models and so on are saved in the Layer2.

To the embodiments of the present disclosure, photo icons, other icons, live-action data and virtual data are saved in different layers of the preset storage location. For example, the photo icons are saved in the Layer1, other icons are saved in the Layer2, the virtual data are saved in the Layer3, and the live-action data are saved in the Layer4. Before an operation of data superposition, the virtual data are selectively acquired from a layer where the virtual data are saved and used as data on which a superposition operation is performed, which can improve a display effect of superposed data and improve an image processing precision.

104: The live-action data and the virtual data are superposed and the superposed data are saved.

To the embodiments of the present disclosure, the superposed data can be saved in a preset save path to improve an efficiency in acquiring the superposed data when the superposed data needs to be further processed and used subsequently.

According to the method for processing an image provided by embodiments of the present disclosure, first of all, a data display characteristic value corresponding to live-action data is acquired, then it is determined whether a similarity between the data display characteristic value and a preset data display characteristic value is less than or equal to a preset threshold, virtual data corresponding to the preset data display characteristic value are acquired from a preset storage location when the similarity is less than or equal to the pre set threshold, where the preset storage location saves virtual data respectively corresponding to different preset data display characteristic values, and finally the live-action data and the virtual data are superposed and superposed data are saved. Compared with a fact that at present when superposing virtual contents and live-action data, generally all content data within a screen are acquired by means of a global screen capturing function of a terminal device and then all the content data are combined with the shot live-action data, in the embodiments of the present disclosure, virtual data matched with live-action images are acquired from a preset storage location for superposition according to data display characteristic values of the live-action images, in this way, an effect in displaying a superposed image can be improved and an image processing precision can be improved.

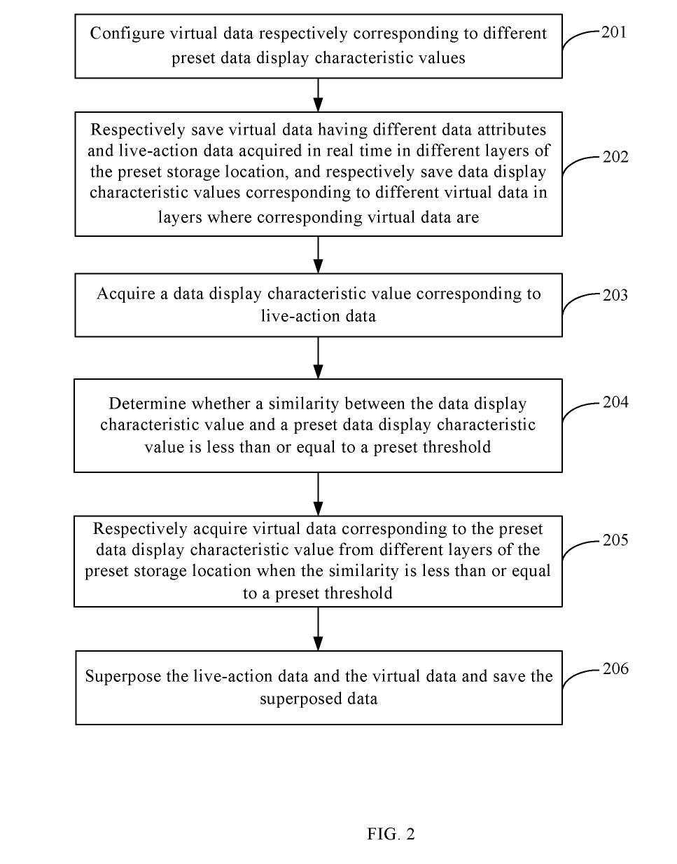

Embodiments of the present disclosure provide another method for processing an image, which can be applied to a terminal device such as a mobile phone, a computer, a personal computer or the like, as shown in FIG. 2, the method includes following steps.

201: Virtual data respectively corresponding to different preset data display characteristic values are configured.

The preset data display characteristic value is used for reflecting the display location of the live-action data. Since live-action data display locations reflected by different preset data display characteristic values are different, corresponding virtual data are respectively configured for different preset data display characteristic values, which can ensure that superposition of the virtual data and the live-action data does not lead to a location overlap, thereby ensuring a display effect of superposed data. Different preset data display characteristic values specifically can be gray values and/or contrast values of data display. Gray values and/or contrast values corresponding to different locations may also be different. Therefore, the specific location of live-action data can be reflected through a gray value and/or a contrast value. Each image datum respectively corresponds to one or one group of gray values and/or contrast values.

202: Virtual data having different data attributes and live-action data acquired in real time are respectively saved in different layers of the preset storage location, and data display characteristic values corresponding to different virtual data are respectively saved in layers where corresponding virtual data are.

Data attributes can be file types, for example, multimedia files and model files are respectively saved in different layers of the preset storage location. Different layers of the preset storage location specifically can be different layers divided according to a layered manner of a system display framework of a smart Android device, for example, divided into three layers by means of layering, a Layer1, a Layer2 and a Layer3 respectively. For example, data whose file types are multimedia files such as video files are saved in the Layer1, and data whose file types are model files such as icons, 3D models and so on are saved in the Layer2.

To the embodiments of the present disclosure, photo icons, other icons, live-action data and virtual data are saved in different layers of the preset storage location. For example, the photo icons are saved in the Layer1, other icons are saved in the Layer2, the virtual data are saved in the Layer3, and the live-action data are saved in the Layer4. Before an operation of data superposition, the virtual data are selectively acquired from a layer where the virtual data are saved and used as data on which a superposition operation is performed, which can improve a display effect of superposed data and improve an image processing precision.

203: A data display characteristic value corresponding to live-action data is acquired.

The live-action data can be real images acquired in real time currently, and the data display characteristic value is used for marking a specific display location of the live-action data. The data display characteristic value specifically can be a gray value and/or a contrast value of data display, which is not limited in the embodiments of the present disclosure. For example, when a shooting instruction is received, live-action data can be acquired by means of a preset camera.

204: It is determined whether a similarity between the data display characteristic value and a preset data display characteristic value is less than or equal to a preset threshold.

The preset threshold can be configured according to actual demands, which is not limited in the embodiments of the present disclosure. For example, when a requirement for an accuracy of superposed data is relatively high, the preset threshold can be configured relatively small. However, when the requirement for the accuracy of superposed data is not high, the preset threshold can be configured relatively large.

205: Virtual data corresponding to the preset data display characteristic value are respectively acquired from different layers of the preset storage location when the similarity is less than or equal to a preset threshold.

To the embodiments of the present disclosure, since live-action data display locations reflected by different preset data display characteristic values are different, virtual data corresponding to the preset data display characteristic value are respectively acquired from different layers of the preset storage location, which can ensure that superposition of the acquired virtual data and the live-action data does not lead to a location overlap, thereby ensuring a display effect of superposed data.

206: The live-action data and the virtual data are superposed and the superposed data are saved.

The superposed data can be saved in a preset save path to improve an efficiency in acquiring the superposed data when the superposed data needs to be further processed and used subsequently. For example, when the superposed data needs to be shared, the superposed data can be directly acquired according to the preset save path, thereby improving the efficiency in acquiring data and an efficiency in sharing images.

To the embodiments of the present disclosure, the superposing the live-action data and the virtual data specifically can include: superposing the live-action data and the virtual data according to an arrangement order of preset layers where the live-action data and the virtual data are. Since display priorities corresponding to different layers are different, the superposing the live-action data and the virtual data according to an arrangement order of preset layers can further improve the display effect of the superposed data. For example, when the live-action data are positioned in the Layer3, videos in the virtual data are positioned in the Layer1, and 3D models in the virtual data are positioned in the Layer2, the superposed data are displayed according to the order of the videos, the 3D models and the live-action data.

Before Step 205, the embodiments of the present disclosure may further include: acquiring virtual data having a maximum content similarity to the live-action data from multiple virtual data when the multiple virtual data exist. The virtual data having a maximum content similarity to the live-action data are acquired from the multiple virtual data and used as virtual data for superposition, in this way, the display effect of the superposed data and the image processing precision can be further improved.

For example, what is displayed in the live-action data is a photo of a certain person in a snow-covered landscape, when multiple virtual data exist, virtual data including scenes related to a theme of snowing are acquired from the multiple virtual data and used as virtual data to be superposed with the live-action data, in this way, the display effect of the superposed data can be further improved.

Before Step 205, the embodiments of the present disclosure may further include: determining whether a content similarity between the virtual data and the live-action data is greater than or equal to a preset threshold; and outputting prompt information for confirming whether to perform a data superposition when the content similarity is smaller than the preset threshold. In the embodiments of the present disclosure, when the content similarity between the virtual data and the live-action data is smaller than the preset threshold, this indicates that the content similarity between the virtual data and the live-action data needing to be superposed is lower, in such a case, the user experience can be improved by outputting prompt information for prompting a user whether to perform a superposition operation, thereby avoiding an unnecessary superposition operation. The prompt information can be text information, audio information, video information and vibration information or the like, which is not limited in the embodiments of the present disclosure.

Further, after Step 205, the method may further include: detecting whether a shared instruction corresponding to the data is received; and acquiring the data from a save path corresponding to the data for sharing when the shared instruction is received. Compared with a fact that at present before sharing superposed data, contents unrelated to live-action data need to be adjusted and filtered out from the superposed data, in the embodiments of the present disclosure, since virtual data used in a superposition operation are filtered data, it is unnecessary to adjust the superposed data, which can be directly shared, thereby improving an efficiency in sharing data.

According to another method for processing an image provided by embodiments of the present disclosure, first of all, a data display characteristic value corresponding to live-action data is acquired, then it is determined whether a similarity between the data display characteristic value and a preset data display characteristic value is less than or equal to a preset threshold, virtual data corresponding to the preset data display characteristic value are acquired from a preset storage location when the similarity is less than or equal to the preset threshold, where the preset storage location saves virtual data respectively corresponding to different preset data display characteristic values, and finally the live-action data and the virtual data are superposed and superposed data are saved. Compared with a fact that at present when superposing virtual contents and live-action data, generally all content data within a screen are acquired by means of a global screen capturing function of a terminal device and then all the content data are combined with the shot live-action data, in the embodiments of the present disclosure, virtual data matched with live-action images are acquired from a preset storage location for superposition according to data display characteristic values of the live-action images, in this way, an effect in displaying a superposed image can be improved and an image processing precision can be improved.

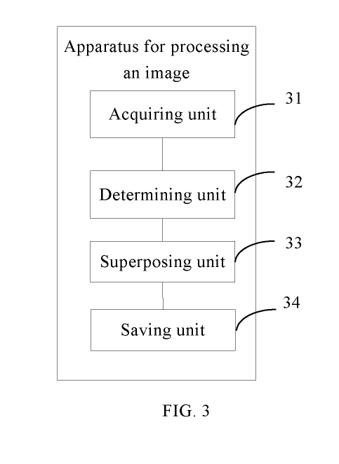

Further, as a concrete implementation of the method as shown in FIG. 1, embodiments of the present disclosure provide an apparatus for processing an image, as shown in FIG. 3, the apparatus for processing an image includes: an acquiring unit 31, a determining unit 32, a superposing unit 33 and a saving unit 34.

The acquiring unit 31 is configured to acquire a data display characteristic value corresponding to live-action data.

The determining unit 32 is configured to determine whether a similarity between the data display characteristic value and a preset data display characteristic value is less than or equal to a preset threshold.

The acquiring unit 31 is further configured to acquire virtual data corresponding to the preset data display characteristic value from a preset storage location when the similarity is less than or equal to the preset threshold, and the preset storage location saves virtual data respectively corresponding to different preset data display characteristic values.

The superposing unit 33 is configured to superpose the live-action data and the virtual data.

The saving unit 34 is configured to save data superposed by the superposing unit 33.

It is to be noted that reference can be made to corresponding description of the method as shown in FIG. 1 for other corresponding description of various function units involved with the apparatus for processing an image provided by embodiments of the present disclosure, which is not unnecessarily elaborated any more herein.

The apparatus for processing an image provided by embodiments of the present disclosure first of all acquires a data display characteristic value corresponding to live-action data, then determines whether a similarity between the data display characteristic value and a preset data display characteristic value is less than or equal to a preset threshold, acquires virtual data corresponding to the preset data display characteristic value from a preset storage location when the similarity is less than or equal to the preset threshold, where the preset storage location saves virtual data respectively corresponding to different preset data display characteristic values, and finally superposes the live-action data and the virtual data and saves superposed data. Compared with a fact that at present when superposing virtual contents and live-action data, generally all content data within a screen are acquired by means of a global screen capturing function of a terminal device and then all the content data are combined with the shot live-action data, in the embodiments of the present disclosure, virtual data matched with live-action images are acquired from a preset storage location for superposition according to data display characteristic values of the live-action images, in this way, an effect in displaying a superposed image can be improved and an image processing precision can be improved.

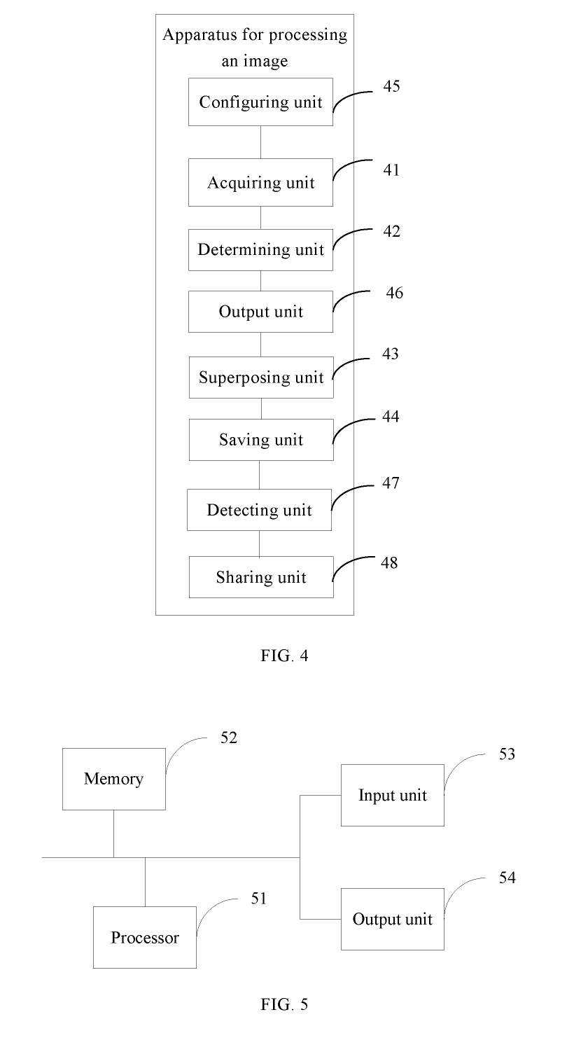

Further, as a concrete implementation of the method as shown in FIG. 2, embodiments of the present disclosure provide another apparatus for processing an image, as shown in FIG. 4, the apparatus for processing an image includes: an acquiring unit 41, a determining unit 42, a superposing unit 43 and a saving unit 44.

The acquiring unit 41 is configured to acquire a data display characteristic value corresponding to live-action data.

The determining unit 42 is configured to determine whether a similarity between the data display characteristic value and a preset data display characteristic value is less than or equal to a preset threshold.

The acquiring unit 41 is further configured to acquire virtual data corresponding to the preset data display characteristic value from a preset storage location when the similarity is less than or equal to the preset threshold, and the preset storage location saves virtual data respectively corresponding to different preset data display characteristic values.

The superposing unit 43 is configured to superpose the live-action data and the virtual data.

The saving unit 44 is configured to save data superposed by the superposing unit 43.

Further, the apparatus further includes: a configuring unit 45.

The configuring unit 45 is configured to configure virtual data respectively corresponding to different preset data display characteristic values.

The saving unit 44 is further configured to respectively save virtual data having different data attributes and live-action data acquired in real time in different layers of the preset storage location, and respectively save data display characteristic values corresponding to different virtual data in layers where corresponding virtual data are.

The acquiring unit 41 is specifically configured to respectively acquire virtual data corresponding to the preset data display characteristic value from different layers of the preset storage location.

The superposing unit 43 is specifically configured to superpose the live-action data and the virtual data according to an arrangement order of preset layers where the live-action data and the virtual data are.

The acquiring unit 41 is further configured to acquire virtual data having a maximum content similarity to the live-action data from multiple virtual data when the multiple virtual data exist.

Further, the apparatus further includes: an output unit 46.

The determining unit 42 is further configured to determine whether a content similarity between the virtual data and the live-action data is greater than or equal to a preset threshold.

The output unit 46 is configured to output prompt information for confirming whether to perform a data superposition when the content similarity is smaller than the preset threshold.

Further, the apparatus further includes:

a detecting unit 47, configured to detect whether a shared instruction corresponding to the data is received; and

a sharing unit 48, configured to acquire the data from a save path corresponding to the data for sharing when the shared instruction corresponding to the data is received.

It is to be noted that reference can be made to corresponding description of the method as shown in FIG. 2 for other corresponding description of various function units involved with the apparatus for processing an image provided by embodiments of the present disclosure, which is not unnecessarily elaborated any more herein.

Another apparatus for processing an image provided by embodiments of the present disclosure first of all acquires a data display characteristic value corresponding to live-action data, then determines whether a similarity between the data display characteristic value and a preset data display characteristic value is less than or equal to a preset threshold, acquires virtual data corresponding to the preset data display characteristic value from a preset storage location when the similarity is less than or equal to the preset threshold, where the preset storage location saves virtual data respectively corresponding to different preset data display characteristic values, and finally superposes the live-action data and the virtual data and saves superposed data. Compared with a fact that at present when superposing virtual contents and live-action data, generally all content data within a screen are acquired by means of a global screen capturing function of a terminal device and then all the content data are combined with the shot live-action data, in the embodiments of the present disclosure, virtual data matched with live-action images are acquired from a preset storage location for superposition according to data display characteristic values of the live-action images, in this way, an effect in displaying a superposed image can be improved and an image processing precision can be improved.

Further, an embodiment of the present disclosure further provides a non-transitory computer-readable storage medium storing executable instructions, which can be executed by an electronic device to perform any methods for processing an image mentioned by embodiments of the present disclosure.

FIG. 5 is a block diagram of an electronic device which is configured to perform the methods for processing an image according to an embodiment of the present disclosure. As shown in FIG. 5, the device includes:

one or more processors 51 and memory 52. A processor 51 is showed in FIG. 5 for an example.

Device which is configured to perform the methods for processing an image can also include: input unit 53 and output unit 54.

Processor 51, memory 52, input unit 53 and output unit 54 can be connected by BUS or other methods, and BUS connecting is showed in FIG. 5 for an example.

Memory 52 can be used for storing non-transitory software program, non-transitory computer executable program and modules as a non-transitory computer-readable storage medium, such as corresponding program instructions/modules for the methods for processing an image mentioned by embodiments of the present disclosure (such as shown in FIG. 3, acquiring unit 31, determining unit 32, superposing unit 33 and saving unit 34). Processor 51 performs kinds of functions and processing an image of the electronic device by executing non-transitory software program, instructions and modules which are stored in memory 52, thereby realizes the methods for processing an image mentioned by embodiments of the present disclosure.

Memory 52 can include program storage area and data storage area, thereby the operating system and applications required by at least one function can be stored in program storage area and data created by using the device for processing an image can be stored in data storage area. Furthermore, memory 52 can include high speed Random-access memory (RAM) or non-volatile memory such as magnetic disk storage device, flash memory device or other non-volatile solid state storage devices. In some embodiments, memory 52 can include long-distance setup memories relative to processor 51, which can communicate with the device for processing an image by networks. The examples of said networks are including but not limited to Internet, Intranet, LAN, mobile Internet and their combinations.

Input unit 53 can be used to receive inputted number, character information and key signals causing user configures and function controls of the device for processing an image. Output unit 54 can include a display screen or a display device.

The said module or modules are stored in memory 52 and perform the methods for processing an image when executed by one or more processors 51.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for processing an image, implemented by an electronic device, comprising:
acquiring a data display characteristic value corresponding to live-action data;
determining whether a similarity between the data display characteristic value and a preset data display characteristic value is less than or equal to a preset threshold;
acquiring virtual data corresponding to the preset data display characteristic value from a preset storage location when the similarity is less than or equal to the preset threshold, wherein the preset storage location saves virtual data respectively corresponding to different preset data display characteristic values; and
superposing the live-action data and the virtual data and saving superposed data.

2. The method for processing an image according to claim 1, wherein before the acquiring live-action data, the method further comprises:
configuring virtual data respectively corresponding to different preset data display characteristic values;
respectively saving virtual data having different data attributes and live-action data acquired in real time in different layers of the preset storage location; and
respectively saving data display characteristic values corresponding to different virtual data in layers where corresponding virtual data are;
the acquiring virtual data corresponding to the preset data display characteristic value from a preset storage location comprises:
respectively acquiring virtual data corresponding to the preset data display characteristic value from different layers of the preset storage location.

3. The method for processing an image according to claim 2, wherein the superposing the live-action data and the virtual data comprises:
superposing the live-action data and the virtual data according to an arrangement order of layers where the live-action data and the virtual data are.

4. The method for processing an image according to claim 1, wherein before the superposing the live-action data and the virtual data, the method further comprises:
acquiring virtual data having a maximum content similarity to the live-action data from multiple virtual data when the multiple virtual data exist.

5. The method for processing an image according to claim 1, wherein before the superposing the live-action data and the virtual data, the method further comprises:
determining whether a content similarity between the virtual data and the live-action data is greater than or equal to a preset threshold; and
outputting prompt information for confirming whether to perform a data superposition when the content similarity is smaller than the preset threshold.

6. The method for processing an image according to claim 1, further comprising:
detecting whether a shared instruction corresponding to the data is received; and
acquiring the data from a save path corresponding to the data for sharing when the shared instruction is received.

7. A non-transitory computer-readable storage medium storing executable instructions, wherein the executable instructions are configured to:
acquire a data display characteristic value corresponding to live-action data;
determine whether a similarity between the data display characteristic value and a preset data display characteristic value is less than or equal to a preset threshold;
acquire virtual data corresponding to the preset data display characteristic value from a preset storage location when the similarity is less than or equal to the preset threshold, wherein the preset storage location saves virtual data respectively corresponding to different preset data display characteristic values; and
superpose the live-action data and the virtual data and save superposed data.

8. The non-transitory computer-readable storage medium according to claim 7, wherein before the step to acquire live-action data, the executable instructions are further configured to:
configure virtual data respectively corresponding to different preset data display characteristic values;
respectively save virtual data having different data attributes and live-action data acquired in real time in different layers of the preset storage location; and
respectively save data display characteristic values corresponding to different virtual data in layers where corresponding virtual data are; and
the step to acquire virtual data corresponding to the preset data display characteristic value from a preset storage location comprises:
respectively acquiring virtual data corresponding to the preset data display characteristic value from different layers of the preset storage location.

9. The non-transitory computer-readable storage medium according to claim 8, wherein the step to superpose the live-action data and the virtual data comprises:
superposing the live-action data and the virtual data according to an arrangement order of layers where the live-action data and the virtual data are.

10. The non-transitory computer-readable storage medium according to claim 7, wherein before the step to superpose the live-action data and the virtual data, the executable instructions are further configured to:
acquire virtual data having a maximum content similarity to the live-action data from multiple virtual data when the multiple virtual data exist.

11. The non-transitory computer-readable storage medium according to claim 7, wherein before the step to superpose the live-action data and the virtual data, the executable instructions are further configured to:
determine whether a content similarity between the virtual data and the live-action data is greater than or equal to a preset threshold; and
output prompt information for confirming whether to perform a data superposition when the content similarity is smaller than the preset threshold.

12. The non-transitory computer-readable storage medium according to claim 7, wherein the executable instructions are further configured to:
detect whether a shared instruction corresponding to the data is received; and
acquire the data from a save path corresponding to the data for sharing when the shared instruction is received.

13. An electronic device, comprising:
at least one processor; and
a memory communicably connected with the at least one processor for storing instructions executable by the at least one processor, wherein execution of the instructions by the at least one processor causes the at least one processor to:
acquire a data display characteristic value corresponding to live-action data;
determine whether a similarity between the data display characteristic value and a preset data display characteristic value is less than or equal to a preset threshold;
acquire virtual data corresponding to the preset data display characteristic value from a preset storage location when the similarity is less than or equal to the preset threshold, wherein the preset storage location saves virtual data respectively corresponding to different preset data display characteristic values; and
superpose the live-action data and the virtual data and save superposed data.

14. The electronic device according to claim 13, wherein before the step to acquire live-action data, the instructions are executed to cause the at least one processor to:
configure virtual data respectively corresponding to different preset data display characteristic values;
respectively save virtual data having different data attributes and live-action data acquired in real time in different layers of the preset storage location; and
respectively save data display characteristic values corresponding to different virtual data in layers where corresponding virtual data are; and
the step to acquire virtual data corresponding to the preset data display characteristic value from a preset storage location comprises:
respectively acquiring virtual data corresponding to the preset data display characteristic value from different layers of the preset storage location.

15. The electronic device according to claim 14, wherein the step to superpose the live-action data and the virtual data comprises:
superposing the live-action data and the virtual data according to an arrangement order of layers where the live-action data and the virtual data are.

16. The electronic device according to claim 13, wherein before the step to superpose the live-action data and the virtual data, the instructions are executed to cause the at least one processor to:
acquire virtual data having a maximum content similarity to the live-action data from multiple virtual data when the multiple virtual data exist.

17. The electronic device according to claim 13, wherein before the step to superpose the live-action data and the virtual data, the instructions are executed to cause the at least one processor to:
determine whether a content similarity between the virtual data and the live-action data is greater than or equal to a preset threshold; and
output prompt information for confirming whether to perform a data superposition when the content similarity is smaller than the preset threshold.

18. The electronic device according to claim 13, wherein the instructions are executed to cause the at least one processor to:
detect whether a shared instruction corresponding to the data is received; and
acquire the data from a save path corresponding to the data for sharing when the shared instruction is received.
